(19) United States
(12) Patent Application Publication
(10) Pub. No.: US 2024/0153394 A1
(43) Pub. Date: May 9, 2024

(54) Computer Software Suite for Logic-Based Interface Augmentation

(71) Applicant: United States of America, as represented by the Secretary of the Navy, Patuxent River, MD (US)

(72) Inventors: Bradford Schroeder, Orlando, FL (US); Jason Hochreiter, Cocoa, FL (US)

(21) Appl. No.: 17/983,918

(22) Filed: Nov. 9, 2022

(51) Int. Cl. G09B 5/06

(52) U.S. Cl. CPC G09B 5/06

(57) ABSTRACT

A computer software suite for inspecting data from an external system and applying user-specified conditional triggers to generate and present augmentations to a user, the suite comprising an editing module and a runtime module. The editing module is for the user to inspect and select data via a general purpose computer, while the editing module is manipulatable based on the data. The editing module can further construct logic for conditionally processing the interface manipulated data. The runtime module is for displaying visual and aural elements based on the logic specified by the user in the editing module.

### STATEMENT OF GOVERNMENT INTEREST

The invention described herein may be manufactured and used by or for the Government of the United States of America for governmental purposes without payment of any royalties thereon or therefor.

### BACKGROUND

The current state-of-the-art training systems can provide feedback to learners using algorithms that process user inputs and performance assessments. Research suggests that this improves learning outcomes and supports the goal for more effective training. Unfortunately, such state-of-the-art training requires bespoke computer programming code specific to the task and system, which may not be possible if the source code for the training interface is not available or if relevant data are not accessible. In addition, these feedback algorithms must be informed by explicit user action or inaction as the feedback algorithms cannot “see” what the user is experiencing in real-time. Therefore, feedback may be less timely, less helpful, less relevant, or less accurate if pertinent task context or data is lacking. Although the utility of these feedback algorithms could be beneficial for other training systems, they are typically inherently tied to a particular system through the development of system-specific code and may be difficult to transition to other applications.

Aside from the current state-of-the-art feedback algorithms, many traditional methods are still in use. For example, human instructors still engage in one-on-one learning and may direct a learner's attention to key areas in the training system. Human instructors might also provide oral feedback in real time if a learner makes a mistake or needs redirection or support. One-on-one teaching is typically considered optimal for learning, but this approach has many limitations. Skilled instructors may not be available for every student, and if they are, it may be cost prohibitive to provide a high level of one-on-one attention to every student. In addition, many training systems involve multitasking scenarios. A human instructor may not be able to attend to all errors that a learner makes, where a feedback algorithm would be better suited to prioritize learning objectives. Moreover, the feedback provided by an instructor is separate from the training system itself, requiring the learner to devote attention to a disjoint set of stimuli that may make focusing on the actual learning task more challenging.

### SUMMARY

The present invention is directed to with the needs enumerated above and below.

The present invention is directed to a computer software suite for inspecting data from an external system and applying user-specified conditional triggers to generate and present augmentations to a user, the suite comprising an editing module for the user to inspect and select data via a general purpose computer, the editing module can be manipulated based on the data, the editing module can further construct logic for conditionally processing the interface manipulated data; and a runtime module for displaying visual and aural elements based on the logic specified by the user in the editing module.

It is a feature of the present invention to provide a computer software suite that expert users or instructors will be able to use to author their own automated feedback and performance algorithms to augment existing computer-based training systems without requiring access to their underlying source code.

It is a feature of the present invention to provide a computer software suite that will be user-friendly enough that anyone who understands an external training system will be able to augment it. Since this invention will use computer vision techniques as a means of monitoring and interpreting learner actions within a training system, the expert user or instructor can avoid time-consuming and costly computer scientist labor required to extract data, design custom feedback algorithms, and integrate these algorithms with the system of interest, which may not always be feasible.

It is a feature of the present invention to provide a computer software suite that requires fewer resources than one-on-one instruction, and provides greater capability than what a one-on-one instructor can accomplish. A one-on-one instructor may not be able to attend to all the important elements of a learner's performance, which require feedback and/or follow-up instruction.

### DRAWINGS

These and other features, aspects and advantages of the present invention will become better understood with reference to the following description and appended claims, and accompanying drawings wherein:

FIG. 1 is a graphical representation of an embodiment of the computer software suite for logic-based interface augmentation; and,

FIG. 2 is a graphical representation of the editing module of the computer software suite graphical user interface.

### DESCRIPTION

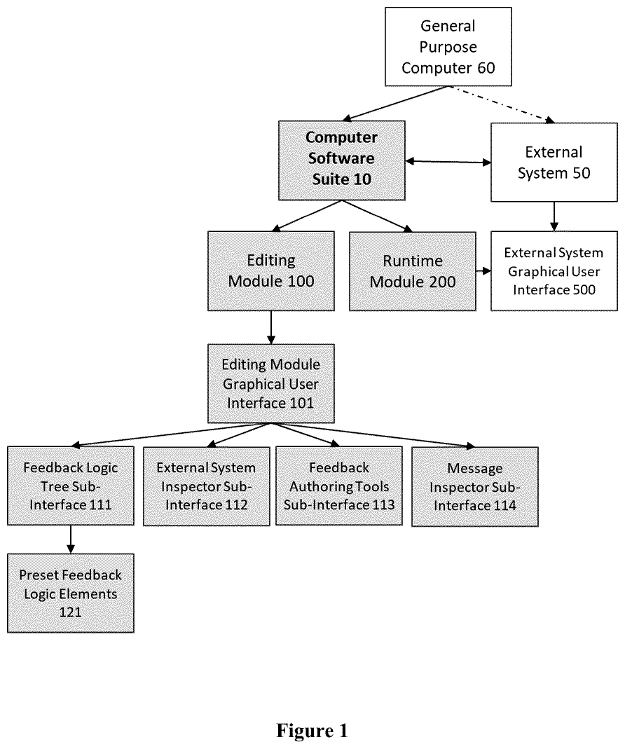

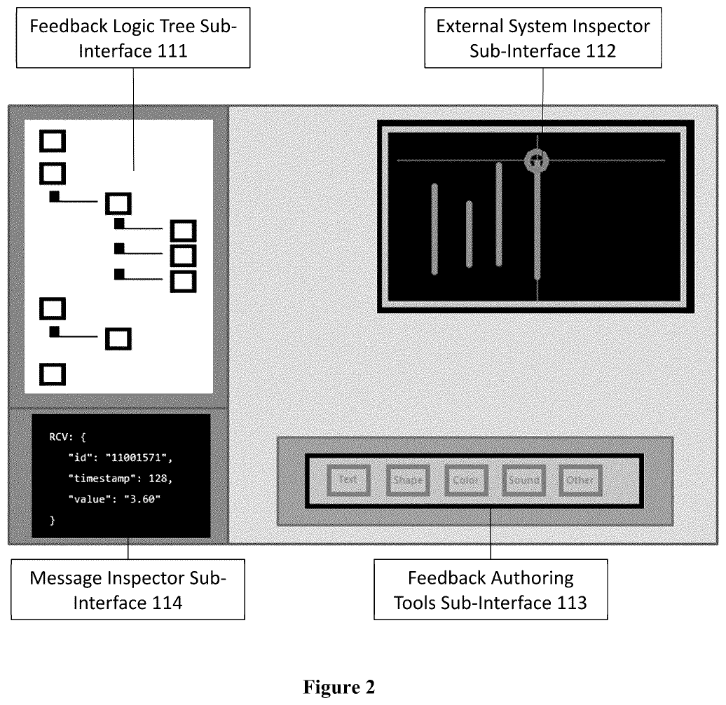

The preferred embodiments of the present invention are illustrated by way of example below and in FIGS. 1-2. The present invention is a computer software suite 10 for inspecting data from an external system 50 and applying user-specified conditional triggers to generate and present augmentations to a learner or trainee of the external system 50. As shown in FIG. 1, the suite 10 includes an editing module 100 for the user to inspect and select data via a general purpose computer 60, and a runtime module 200 for displaying visual and aural elements on an external system 50 based on logic specified by the user in the editing module 100. The editing module 100 can be manipulated based on the data, and the editing module 100 can further construct logic for conditionally processing the interface manipulated data.

In the description of the present invention, the invention will be discussed in a military environment; however, this invention can be utilized for any type of training application.

The present invention is a system-agnostic software suite that integrates passive real-time image analysis methods (Artificial Intelligence/Machine Learning or AI/ML) into existing training systems to monitor learners and support advanced instructional and diagnostic feedback algorithms. Using the computer software suite 10, an instructor or expert user can sample specific visual or other data from external training systems to develop models in a supervised learning framework, allowing for the creation of high-resolution, timely, guided, and co-located feedback and performance algorithms.

The data can be obtained, but without limitation, by using one or more AI/ML techniques. Such techniques include, but without limitation, via computer vision, image recognition, and/or optical character recognition to generate a data source for feedback algorithms. For example, but without limitation, the computer software suite 10 may be able to analyze images and text displayed by the external system 50. As shown in FIG. 1, the editing module 100 includes an editing module graphical user interface 101 that allows an instructor or expert user to connect the data to rule-based triggers that initiate specified routines, including but not limited to, displaying overlaid/co-located feedback, generating data logs, or other actions, in response to actions performed by the learner. For example, but without limitation, the computer software suite 10 may have a rule-based trigger to detect that a learner has selected a button and consequently display a pre-specified feedback overlay when the user selects that button, provided other pre-specified conditions (e.g., elapsed time or other contextual factors) have been satisfied. In this example, visual data collected from the external system 50 may be evaluated by a user-specified image processing routine to determine that the learner has clicked on a button and further processed by an optical character recognition engine to determine the text shown on that button in order to initiate the pre-specified feedback augmentations. As data are collected via visual analysis techniques, the rule-based trigger framework can be used for the augmentation of existing computer-based training interfaces without requiring any internal modifications to them.

As discussed above, the computer software suite 10 includes two modes or modules—the editing module 100 and the runtime module 200, both utilizing a general purpose computer 60. The editing module 100 is a tool used by an instructional user (e.g., but without limitation, an instructor or other expert user) to selectively sample a graphical user interface 500 of the external system to create logical triggers to augment this interface (e.g., but without limitation, with co-located visual or aural feedback displays). The external system 50 is another system (e.g., but without limitation, another software program) that the expert user/instructor wishes to analyze, modify, or augment with the computer software suite 10. The external system 50 and the computer software suite 10 may be running on the same general purpose computer 60, they may be connected via a network connection, or communicating via any other means. Additionally, the external system 50 may be able to communicate with the computer software suite 10 via standard network communication protocols, file logging capabilities, or any other communications method practicable. While the computer software suite 10 is running, the instructional user will have the editing module 100 enabled. The editing module graphical user interface 101 allows the instructional user to customize augmentations for the external system 50. As shown in FIG. 2, the editing module graphical user interface 101 contains several sub-interfaces (a feedback logic tree sub-interface 111, external system inspector sub-interface 112, feedback authoring tools sub-interface 113, and message inspector sub-interface 114) that allow the instructional user to specify these augmentations, as described below. With the editing module graphical user interface 101, the instructional user's customized augmentations can be saved into computer software suite 10 and later used to augment the external system 50.

The editing module 100 provides an intuitive interface allowing an instructional user (e.g., but without limitation, an instructor or expert user) to create a supervised model (e.g., but without limitation, internally achieved via AI, ML, or computer vision techniques) to recognize specific conditions within an external system interface (e.g., but without limitation, a training system) under which the computer software suite 10 will respond with prechosen actions. These actions could include displaying co-located feedback on the external system 50 or logging specific data to a file. The instructional user can author customizable augmentations for the external system 50 that can be displayed when using the runtime module 200. With the feedback logic tree sub-interface 111, the instructional user can specify logic to control under what conditions customized augmentations should be displayed on the external system 50.

As shown in FIG. 1, the feedback logic tree sub-interface 111 contains preset feedback logic elements 121 that allow the instructional user to customize this logic through common software interaction use cases (e.g., but without limitation, elapsed time, button presses, or mouse clicks). However, the instructional user may also create their own chosen feedback logic using data extracted via the external system inspector sub-interface 112. This feedback logic could include one or more hierarchies of Boolean logic conditions that the computer software suite 10 evaluates over these extracted data. These conditions may further specify processing rules for this data (e.g., specific image processing techniques used to facilitate interpretation of the visual imagery of the external system 50). Additionally, for an external system 50 that outputs data including, but not limited to, file logging capabilities or data messages transmitted over standard network communication protocols (e.g., UDP (User Datagram Protocol)), the message inspector sub-interface 114 allows the instructional user to inspect these outputs and configure them for use as an additional data source for specifying triggers.

The external system inspector sub-interface 112 allows the instructional user to view the external system graphical user interface 500 of the external system 50. Within the view provided by the external system inspector sub-interface 112, the instructional user can select graphical elements contained within the external system graphical user interface 500. These selected graphical elements can be used as a source of data for feedback logic and/or locations on which the instructional user wishes to display co-located feedback callouts, which they specify via the feedback logic tree sub-interface 111. Once a region of interest is selected, the external system inspector sub-interface 112 shows a preview, allowing the instructional user to specify how the region of the external system graphical user interface 500 should be processed to generate data for use in logical triggers and/or select where co-located feedback should be displayed in the external system graphical user interface 500. For example, an instructional user may select a particular graphical element, and then create logic based on that selection. In operation, when the indicated graphical element appears on the external system graphical user interface 500, the computer software suite 10 displays a textual message or plays an audio clip on the external system 50. The message inspector sub-interface 114 can be used in a similar fashion, allowing an instructional user to inspect data output by the external system 50 to support logic creation. While creating logic, the instructional user may use the feedback authoring tools sub-interface 113 to customize the outputs of the created logic (e.g., but without limitation, the shape of visual feedback overlays, the color of text or visual feedback overlays, and sounds), which may be contained within the computer software suite 10 or provided by the instructional user.

The runtime module 200 can be used by a non-instructional user (including, but not limited to, a student or trainee). The customizations created by the instructional user in the editing module 100 and saved to the computer software suite 10 are loaded by the runtime module 200. The runtime module 200 runs in the background alongside the external system 50, analyzes it per the logical triggers defined by the instructional user in the editing module 100, and displays these same customizations in the external system graphical user interface 500 in real time when the logical triggers are satisfied. Therefore, when another user (such as the instructor's student) is using the external system 50 with the external system graphical user interface 500, they will see the customized augmentations that the instructional user created in the editing module 100 of the computer software suite 10.

When an instructional user analyzes data from the external system 50, computer software suite 10 functions as a tool to provide the instructional user the capability to customize the interface augmentations on external system 50. It does not create interface augmentations automatically. Rather, computer software suite 10 exposes the capabilities of artificial intelligence and machine learning technology to the instructional user who may not possess the computer programming skills necessary to create interface augmentations on their own. For example, but without limitation, without interacting with the code of the external system 50, an instructional user who is familiar with using the external system 50 can modify button actions, display helpful guides, highlight relevant and timely information, or generate an audio clip with the logical triggers they create within the editing module 100. Further, the computer software suite 10 can also provide the capability to modify an external system 50 that can no longer be modified for reasons such as, but not limited to, inaccessible source code, outdated operating systems, or inability to recompile or rebuild an external system 50.

Compared to the current state-of-the-art computer-based training, the present invention offers numerous advantages. While current computer-based training systems are capable of analyzing the performance data of learners, they are typically limited to the analysis of explicit, discrete learner actions, which can prevent the training system from providing relevant, timely feedback. Additionally, the creation of such training systems often requires direct access to the underlying source code of a computer-based system, which may not be available. Such training systems also tend to require development that is inherently tied to a specific computer-based system, limiting the applicability of this training to other computer-based systems. However, the computer software suite 10 is capable of continuous data analysis via the logical elements created by an instructional user in the feedback logic tree sub-interface 111, and such logic can be created for general computer-based training systems without requiring system-specific software development.

Furthermore, while one-on-one training via human instructors is generally considered optimal for learning purposes, such training poses many challenges that are addressed by the computer software suite 10. In particular, instructors capable of providing relevant training for a given computer-based system may be costly or be unavailable, and human instructors are limited in their ability to provide attention to multiple learners simultaneously and/or in multitasking scenarios. The automated feedback capabilities of the computer software suite 10, facilitated by the data analysis techniques utilized by the runtime module 200 and controlled by the instructor-provided logic in the feedback logic tree sub-interface 111, can provide timely guided feedback in these situations and do not require multiple human instructors. In addition, while training provided by a human instructor is often limited to oral feedback or visual feedback separate from the computer-based system, the computer software suite 10 is capable of co-locating feedback interventions directly into the external system 50 (for example, but without limitation, by overlaying textual feedback on top of the external system graphical user interface 500).

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A computer software suite for inspecting data from an external system and applying user-specified conditional triggers to generate and present augmentations to a user, the suite comprising:
an editing module for the user to inspect and select data via a general purpose computer, the editing module manipulatable based on the data, the editing module can further construct logic for conditionally processing the interface manipulated data; and,
a runtime module for displaying visual and aural elements based on the logic specified by the user in the editing module.
